(19) United States
(12) Patent Application Publication
(10) Pub. No.: US 2026/0209657 A1
(43) Pub. Date: Jul. 23, 2026

(54) CLEANING AND DRYING OF SYRUP FEEDSTOCKS FROM ETHANOL DISTILLATION PROCESSES

(71) Applicant: LucasE3, L.C., Shawnee, KS (US)

(72) Inventor: Scott A. Lucas, De Soto, KS (US)

(21) Appl. No.: 19/450,893

(22) Filed: Jan. 16, 2026

Related U.S. Application Data
(60) Provisional application No. 63/746,672, filed on Jan. 17, 2025.

(51) Int. Cl. C12F 3/10

(52) U.S. Cl. CPC C12F 3/10

(57) ABSTRACT

Systems, methods, and devices for cleaning and drying a syrup feedstock from an ethanol distillation process. The syrup feedstock is washed with water to remove at least a portion of glycerol from the syrup feedstock to form a clean syrup comprising solids, such as proteins and fibers. The solids are then dried and separated from the clean syrup using one or more dryers and/or separators to form a high-protein dried product comprising at least 35% protein.

### RELATED APPLICATIONS

This non-provisional patent application claims priority benefit, with regard to all common subject matter, of earlier-filed U.S. Provisional Patent Application No. 63/746,672, filed on January 17, 2025, and entitled "CLEANING AND DRYING OF SYRUP FEEDSTOCKS FROM ETHANOL DISTILLATION PROCESSES." The identified earlier-filed provisional patent application is hereby incorporated by reference in its entirety into the present application.

### BACKGROUND

### 1. Field

Embodiments of the present disclosure generally relate to the treatment of spent stillage remaining after the distillation of ethanol. More specifically, embodiments of the present disclosure relate to processes for cleaning and drying syrup from an ethanol distillation process to form a high-protein product.

### 2. Related Art

Ethanol distillation processes recover ethanol via the fermentation of organic feedstocks, such as corn, wheat, barley, soy, beans, milo, and other grains, to form beer. The beer is then distilled to separate ethanol from the remaining whole stillage. Current ethanol distillation processes produce a plurality of products from the remaining whole stillage to increase the economic performance of the ethanol distillation process. For example, the whole stillage may be sent to a centrifuge to remove thin stillage from wet distillers grains such that the thin stillage can be fed to evaporators to produce oils and syrup. The oils (e.g., corn oil) are sold while the syrup is added to the wet distiller grains and dried to form a dried distiller grains product that can be utilized as animal feed. However, the syrup from ethanol distillation processes usually contains glycerol, which causes the syrup to be sticky and harder to process. For example, glycerol can cause the formation of tars in the dryers that require frequent cleaning of the dryers to prevent buildup and fouling of the dryers. Accordingly, current ethanol distillation processes lack processes to convert whole stillage components to valuable products while reducing the formation of tars.

### SUMMARY

Embodiments of the present disclosure solve the above-mentioned problems by providing systems and methods for cleaning and drying syrup from an ethanol distillation process. In particular, embodiments of the present disclosure include a process for cleaning the syrup feedstock via a washing chamber to form a clean syrup having less glycerol than the syrup feedstock. Further, embodiments of the present disclosure include a process for drying the clean syrup via one or more dryers and/or separators to form a high-protein (e.g., at least 35%, at least 40%, at least 45%, at least 50%, or at least 55% protein) dried product. Accordingly, embodiments of the present disclosure produce higher-value, higher-quality products than previously achievable while reducing energy costs of the ethanol distillation process.

In some embodiments, the techniques described herein relate to a process for cleaning and drying a syrup feedstock including protein, fiber, and glycerol, the process including: flowing the syrup feedstock through a membrane system in a first direction; flowing water through the membrane system in a second direction opposite the first direction such that the syrup feedstock contacts the water to remove at least a portion of the glycerol from the syrup feedstock to form a clean syrup and dilute glycerol; mixing the clean syrup with air to dry the clean syrup; separating a dried product from the air using one or more separators, wherein the dried product includes at least 40% protein and at least 10% fibers; and condensing the dilute glycerol via an evaporator using heat from the air to form a glycerol product, wherein the glycerol product includes at least 10% glycerol.

In some embodiments, the techniques described herein relate to a process, further including: heating the air to a temperature of at least 300°F via a fired heater.

In some embodiments, the techniques described herein relate to a process, wherein separating the dried product from the air includes feeding a mixture including the clean syrup and the air to a baghouse filter system.

In some embodiments, the techniques described herein relate to a process, wherein separating the dried product from the air further includes feeding the mixture to a cyclone filter system prior to feeding the mixture to the baghouse filter system.

In some embodiments, the techniques described herein relate to a process, further including prior to feeding the syrup feedstock to the membrane system, feeding the syrup feedstock to a strainer to remove solids having a diameter of 300 μm or greater.

In some embodiments, the techniques described herein relate to a process, wherein mixing the clean syrup with the air includes feeding the clean syrup and the air to a spray dryer.

In some embodiments, the techniques described herein relate to a process, wherein the one or more separators includes at least one of a cyclone filter system, a baghouse filter system, an electrostatic precipitator, a scrubber, a gravity settling chamber, or a sieve separator.

In some embodiments, the techniques described herein relate to a process for cleaning and drying a syrup feedstock including protein, fiber, and glycerol, the process including: feeding the syrup feedstock and water to a washing chamber such that the syrup feedstock contacts the water to remove at least a portion of the glycerol from the syrup feedstock to form a clean syrup and dilute glycerol; and removing water from the clean syrup via one or more separators or dryers to form a dried product, wherein the dried product includes at least 50% protein.

In some embodiments, the techniques described herein relate to a process, further including condensing the dilute glycerol to form a glycerol product including at least 15% glycerol.

In some embodiments, the techniques described herein relate to a process, further including: flowing the syrup feedstock through the washing chamber in a first direction; and flowing the water through the washing chamber in a second direction opposite the first direction.

In some embodiments, the techniques described herein relate to a process, wherein the washing chamber is a membrane system configured to remove at least a portion of water-soluble contaminants from the syrup feedstock to form the clean syrup.

In some embodiments, the techniques described herein relate to a process, wherein the one or more separators or dryers includes at least one of a cyclone filter system, a baghouse filter system, an electrostatic precipitator, a scrubber, a gravity settling chamber, or a sieve separator, a spray dryer, a rotary dryer, a flash dryer, a tunnel dryer, a conveyor dryer, a counterflow dryer, an air flow dryer, a vacuum dryer, or a heat dryer.

In some embodiments, the techniques described herein relate to a process, wherein the one or more separators includes the spray dryer, the cyclone filter system, and the baghouse filter system.

In some embodiments, the techniques described herein relate to a process, further including prior to feeding the syrup feedstock to the washing chamber, feeding the syrup feedstock to one or more filters to remove at least a portion of solids having a diameter of 200 μm or greater.

In some embodiments, the techniques described herein relate to a process for cleaning and drying a syrup feedstock including protein, fiber, and glycerol, the process including: flowing the syrup feedstock through a washing chamber in a first direction; flowing water through the washing chamber in a second direction such that the syrup feedstock contacts the water to remove at least a portion of the glycerol from the syrup feedstock to form a clean syrup and dilute glycerol; feeding the clean syrup to a spray dryer such that the clean syrup mixes with air having a temperature of at least 300°F to dry the clean syrup; separating a dried product from the air using at least one of a cyclone filter system or a baghouse filter system, wherein the dried product includes at least 35% protein and at least 5% fibers; and condensing the dilute glycerol via heat from the air to form a glycerol product, wherein the glycerol product includes at least 10% glycerol.

In some embodiments, the techniques described herein relate to a process, wherein condensing the dilute glycerol includes: feeding the air from the at least one of the cyclone filter system or the baghouse filter system to a heat scrubber; spraying water in the heat scrubber to remove heat from the air to form a hot water stream; feeding the hot water stream and at least a portion of the dilute glycerol to a heat exchanger to heat the portion of the dilute glycerol; and feeding the portion of the dilute glycerol to an evaporator to condense the dilute glycerol to form the glycerol product.

In some embodiments, the techniques described herein relate to a process, wherein the water sprayed in the heat scrubber includes the hot water stream after being fed to the heat exchanger to heat the portion of the dilute glycerol.

In some embodiments, the techniques described herein relate to a process, wherein the dilute glycerol is fed to the evaporator to evaporate at least a portion of water in the dilute glycerol to form the glycerol product.

In some embodiments, the techniques described herein relate to a process, wherein the washing chamber removes at least 75% of the glycerol from the syrup feedstock to form the clean syrup.

In some embodiments, the techniques described herein relate to a process, wherein the dried product includes less than 15% water.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWINGS

Embodiments of the present disclosure are described in detail below with reference to the attached drawing figures, wherein:

FIG. 1 depicts a schematic view of an exemplary process for cleaning a syrup feedstock relating to some embodiments;

FIG. 2 depicts a schematic view of an exemplary process for drying a clean syrup feedstock relating to some embodiments;

FIG. 3 depicts a schematic view of an exemplary process for condensing a glycerol stream relating to some embodiments; and

FIG. 4 depicts a method for producing one or more products from a syrup feedstock relating to some embodiments.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description of embodiments of the present disclosure references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized, and changes can be made without departing from the scope of the present disclosure. Therefore, the following detailed description is not to be taken in a limiting sense. The scope of embodiments of the present disclosure is defined only by the appended claims, along with the full scope of equivalents to which such claims are entitled.

In this description, references to "one embodiment," "an embodiment," or "embodiments" mean that the feature or features being referred to are included in at least one embodiment of the technology. Separate reference to "one embodiment," "an embodiment," or "embodiments" in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

It should be understood that any numerical range recited herein may be inclusive to the bounds of the range and include all sub-ranges subsumed therein. For example, a range of “50% to 75%” may include any and all sub-ranges between and including the recited minimum value of 50% and the recited maximum value of 70%, that is, all sub-ranges beginning with a minimum value equal to or greater than 50% and ending with a maximum value equal to or less than 70%, and all sub-ranges in between, e.g., 50% to 62%, 65% to 70%, or 67% to 75%. Further, the percentages described herein may refer to a weight basis, a volumetric basis, or a molar basis. For example, a syrup feedstock comprising 50% of a first material may be used to describe a syrup feedstock comprising 50% of a first material based on weight, based on volume, or based on moles.

As described above, previous techniques for treating syrup from ethanol distillation processes include feeding the syrup to a dryer with wet distillers grain to form a dried distillers grain product utilized as feed for livestock including cattle. Further, drying syrup containing glycerol may form tars in the dryer that require frequent cleaning of the dryer. The present disclosure provides techniques for upgrading the syrup from the evaporator to produce a higher quality, higher protein product (e.g., a product comprising at least 35%, at least 40%, at least 45%, at least 50%, or at least 55% protein). Further, the present disclosure removes at least a portion of the glycerol from the syrup to reduce or prevent the formation of tars. Accordingly, the present disclosure provides systems and methods for cleaning and drying syrups from ethanol distillation to produce higher quality products than previous techniques for upgrading at least a portion of the whole stillage from ethanol distillation products.

The present disclosure includes a first process for cleaning a syrup feedstock received from an ethanol distillation process to form a clean syrup. The first process includes feeding the syrup feedstock and water to a washing chamber to remove at least a portion of glycerol and/or contaminants from the syrup feedstock to form the clean syrup. The present disclosure further includes a second process for drying the clean syrup. The second process includes drying and separating at least a portion of solids (e.g., protein, fiber, and/or yeast) from the clean syrup via one or more dryers and/or separators. The present disclosure further includes a third process for condensing a dilute glycerol stream. The third process includes one or more separators and/or heat exchangers to remove at least a portion of water from the dilute glycerol stream to form a condensed glycerol product. Accordingly, the present disclosure includes one or more processes for converting syrup from an ethanol distillation process into one or more products to increase the economic performance of the ethanol distillation process.

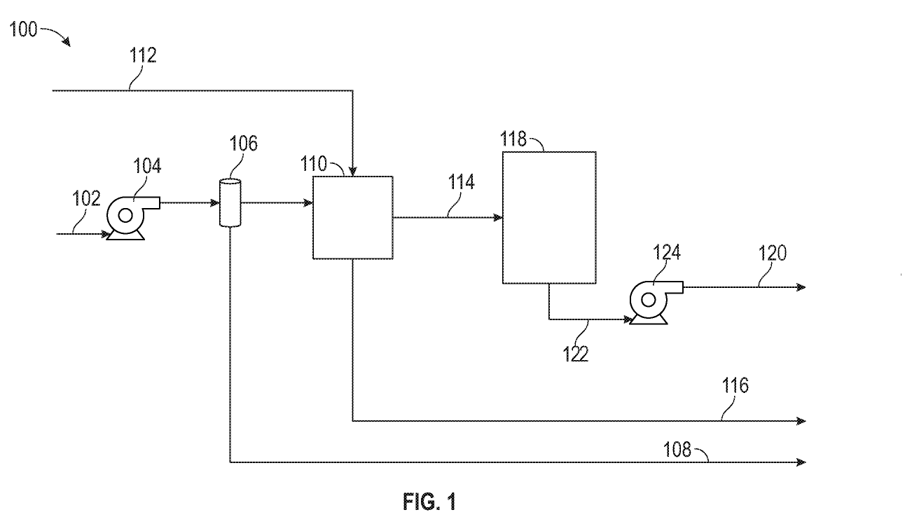

FIG. 1 depicts a schematic view of an exemplary process 100 for cleaning a syrup feedstock stream 102 to form a clean syrup stream 120. In some embodiments, process 100 comprises a washing chamber 110 configured to clean the syrup feedstock stream 102. In some embodiments, syrup feedstock stream 102 is fed to washing chamber 110 with a water stream 112 to clean the syrup feedstock stream 102. For example, syrup feedstock stream 102 and water stream 112 may flow through washing chamber 110 such that syrup feedstock stream 102 contacts water stream 112 and transfers contaminants, such as glycerol and salt, from syrup feedstock stream 102 to water stream 112. Removing at least a portion of the contaminants from syrup feedstock stream 102 via water stream 112 forms a clean syrup stream 114 and a dilute glycerol stream 116. Washing chamber 110 may reduce the number of contaminants in syrup feedstock stream 102 by at least 50%, at least 60%, at least 70%, at least 75%, at least 80%, at least 85%, or at least 90% to form clean syrup stream 114. For example, washing chamber 110 may reduce the amount of glycerol in syrup feedstock stream 102 by at least 75% to form clean syrup stream 114.

Removing at least a portion of the contaminants (e.g., salt and/or glycerol) may allow for the formation of higher quality products (i.e., products that can be sold at a higher value) compared to products previously made using syrup from an ethanol distillation system. For example, clean syrup stream 114 may be further processed to make a dried product containing a high amount of protein (e.g., at least 35%, at least 40%, at least 45%, at least 50%, or at least 55% protein). Further, removing glycerol from the syrup feedstock stream 102 may reduce or prevent the formation of tars in subsequent processing units. Comparatively, processing syrup feedstocks containing glycerol may form tars in dryers that would require frequent shutdown and maintenance of the dryer to remove. In some embodiments, diverting the syrup from the ethanol distillation process to the processes described herein reduces the amount of material fed to the dryers of the ethanol distillation process used to produce dried distillers grains thereby reducing the gas usage of the dryers in the ethanol distillation process and increasing the efficiency of the ethanol distillation process. Further, diverting the syrup from the ethanol distillation process to the processes described herein increases the oil recovery of the dryers used to produce dried distillers grains thereby further increasing the efficiency of the ethanol distillation process.

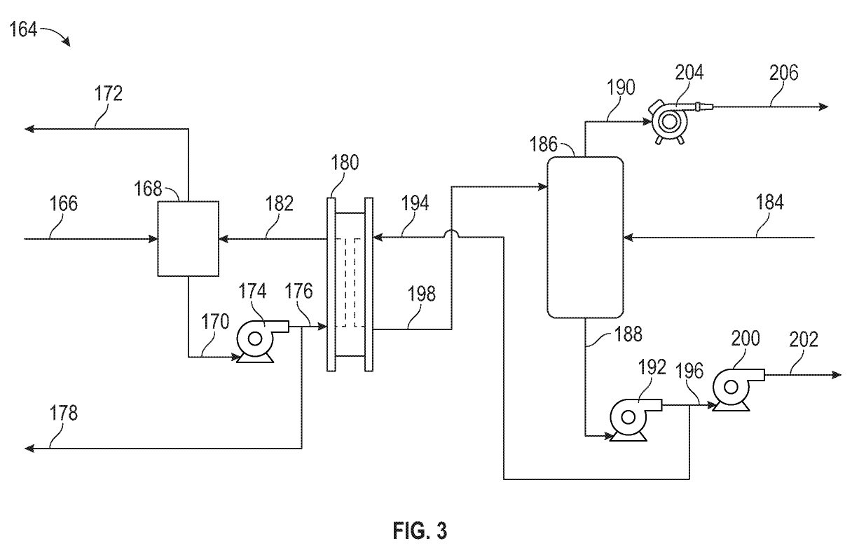

In some embodiments, syrup feedstock stream 102 may comprise at least 2.5%, at least 5%, at least 10%, at least 15%, at least 20%, at least 25%, at least 30%, or at least 35% glycerol content and/or at least 1%, at least 2%, at least 3%, at least 4%, or at least 5% salt content. For example, syrup feedstock stream 102 may comprise 25% glycerol content and 2% salt content. Accordingly, process 100 described herein may reduce the glycerol and salt content in syrup feedstock stream 102 to less than 5%, less than 2.5%, less than 2%, less than 1.5%, less than 1%, or less than 0.5% glycerol content and less than 2%, less than 1%, less than 0.5%, or less than 0.1% salt content. For example, process 100 may reduce syrup feedstock stream 102 having a 5% glycerol content and a 2% salt content to less than 1.5% glycerol and less than 0.5% salt. In some embodiments, the removed glycerol (i.e., dilute glycerol stream 116) may be further processed to form a glycerol product. For example, dilute glycerol stream 116 may be sent to process 164 to form condensed glycerol product stream 178 as described below in FIG. 3.

In some embodiments, washing chamber 110 may be any combination of cleaning systems now known or later developed, including, but not limited to, a membrane system, a spraying system, a submersion system, and a mixing system. In some embodiments, washing chamber 110 may be a membrane system configured to remove at least a portion of contaminants from syrup feedstock stream 102. For example, the membrane system may have one or more membranes configured to prevent permeation of solid materials, such as proteins and/or fibers and allow permeation of water and water-soluble contaminants, such as glycerol and/or salt such that the contaminants and the solids are separated. In some embodiments, syrup feedstock stream 102 flows through washing chamber 110 in a first direction and water stream 112 flows through washing chamber 110 in a second direction. For example, syrup feedstock stream 102 may flow through washing chamber 110 in a first direction and water stream 112 may flow through washing chamber 110 in a second direction opposite the first direction. Embodiments are contemplated in which syrup feedstock stream 102 and water stream 112 flow through washing chamber 110 using cocurrent flow, countercurrent flow, and/or crossflow. For example, washing chamber 110 may be a membrane system similar to a heat and frame heat exchanger in which syrup feedstock stream 102 and water stream 112 flow countercurrently to form clean syrup stream 120.

In some embodiments, syrup feedstock stream 102 may be sourced from an ethanol distillation process. As described above, an ethanol distillation process may comprise one or more separators (e.g., a centrifuge) for separating whole stillage into a thin stillage and wet grains. The thin stillage may then be sent to one or more evaporators configured to convert the thin stillage into one or more products, such as syrup. Accordingly, syrup feedstock stream 102 may comprise a mixture of solids and liquids from an ethanol distillation process. Syrup feedstock stream 102 may comprise of any combination of protein, fiber, yeast, salt, glycerol, or water from the whole stillage of an ethanol distillation process. For example, syrup feedstock stream 102 may comprise at least 1%, at least 2.5%, at least 5%, at least 7.5%, or at least 10% of protein, at least 1%, at least 2%, at least 3%, at least 4%, or at least 5% of fiber, at least 5%, at least 10%, at least 15%, at least 20%, or at least 25% of yeast, at least 1%, at least 2%, at least 3%, at least 4%, or at least 5% of salt, at least 2.5%, at least 5%, at least 10%, at least 15%, at least 20%, or at least 25% of glycerol, and/or at least 50%, at least 60%, or at least 70% water. Embodiments are contemplated in which syrup feedstock stream 102 may be sourced from other processes.

Process 100 may further comprise a solid strainer 106 configured to strain out larger solid particles from syrup feedstock stream 102. In some embodiments, solid strainer 106 may remove solids having a diameter of 400 micrometer (μm) or greater, 350 μm or greater, 300 μm or greater, 250 μm or greater, 200 μm or greater, 150 μm or greater, or 100 μm or greater from syrup feedstock stream 102. For example, solid strainer 106 may remove solids, such as fibers and proteins, having a diameter of 250 μm or greater from syrup feedstock stream 102. In some embodiments, feeding syrup feedstock stream 102 through solid strainer 106 forms solids stream 108 comprising the solids filtered out from syrup feedstock stream 102. For example, solids stream 108 may comprise solids having a diameter of 400 micrometer μm or greater, 350 μm or greater, 300 μm or greater, 250 μm or greater, 200 μm or greater, 150 μm or greater, or 100 μm or greater. In some embodiments, solid strainer 106 may be any combination of filters, gravity separators, centrifuges, hydrocyclones, classifiers, or other known solid-liquid separation devices now know or later developed. Embodiments are contemplated in which solid strainer 106 is omitted from process 100. For example, solid strainer 106 may be omitted such that a solid strainer does not remove solids from syrup feedstock stream 102. In some embodiments, solids stream 108 may be further processed by a dryer. For example, solids stream 108 may be fed with wet distillers grains to a dryer to form dried distillers grains.

In some embodiments, process 100 comprises a pump 104 configured to pressurize syrup feedstock stream 102. Further, pump 104 may pressurize syrup feedstock stream 102 to facilitate the flow of syrup feedstock stream 102 through one or more units in process 100, such as solid strainer 106. Pump 104 may pressurize syrup feedstock stream 102 to a pressure of at least 15 pounds per square inch absolute (psia), at least 25 psia, at least 50 psia, at least 75 psia, at least 100 psia, at least 125 psia, or at least 150 psia. Pump 104 may be any pressurization device now known or later developed, such as a positive displacement pump, a rotary pump, a reciprocating pump, an axial-flow pump, a radial-flow pump, or a regenerative turbine pump. Embodiments are contemplated in which pump 104 may be omitted. For example, syrup feedstock stream 102 may have previously been pressurized from an upstream process, such as an ethanol distillation process and therefore may not be fed to pump 104.

Process 100 may further comprise a holding tank 118 configured to control at least one of a temperature, a pressure, or a flow rate of clean syrup stream 120. Embodiments are contemplated in which any combination of devices may be utilized to control at least one of the temperature, the pressure, or the flow rate of clean syrup stream 120. For example, one or more heat exchangers may be utilized to control the temperature of clean syrup stream 120 and/or one or more pumps may be utilized to control the pressure of clean syrup stream 120. Embodiments are also contemplated in which holding tank 118 may be omitted such that clean syrup stream 114 continues in process 100 without entering a holding tank.

In some embodiments, clean syrup stream 122 flowing from holding tank 118 may be fed to a pump 124 to pressurize clean syrup stream 114. Pump 124 may pressurize clean syrup stream 120 to a pressure of at least 15 psia, at least 25 psia, at least 50 psia, at least 75 psia, at least 100 psia, at least 125 psia, or at least 150 psia. For example, pump 124 may pressurize clean syrup stream 120 to a pressure of 50 psia. Embodiments are contemplated in which pump 124 is omitted from process 100. For example, clean syrup stream 122 may not require further pressurization and therefore may not be fed to pump 124.

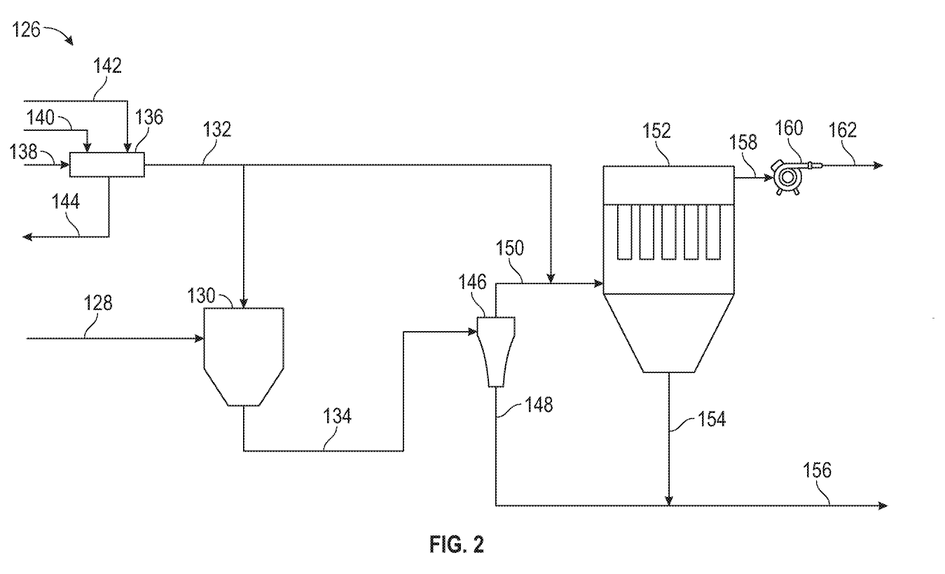

Clean syrup stream 120 comprises a lower percentage of contaminants, such as glycerol and/or salt, compared to syrup feedstock stream 102. In some embodiments, process 100 reduces the contaminants in syrup feedstock stream 102 by at least 50%, at least 60%, at least 70%, at least 75%, at least 80%, at least 85%, or at least 90% to form clean syrup stream 120. For example, process 100 may remove at least 80% of glycerol from syrup feedstock stream 102 to form clean syrup stream 120. Similarly, dilute glycerol stream 108 may comprise at least 50%, at least 60%, at least 70%, at least 75%, at least 80%, at least 85%, or at least 90% of the glycerol and/or contaminants from syrup feedstock stream 102. In some embodiments, clean syrup stream 120 may be further processed to produce a solid product. For example, as described below in FIG. 2, process 126 may convert a clean syrup stream (e.g., clean syrup stream 128) to a solid product 154. Similarly, dilute glycerol stream 108 may be further processed to produce a glycerol product. For example, as described below in FIG. 3, process 164 may condense a dilute glycerol stream (e.g., dilute glycerol stream 108) to produce a condense glycerol product.

FIG. 2 depicts a schematic view of an exemplary process 126 for drying a clean syrup stream 128 to form a solid product 156. In some embodiments, process 126 comprises one or more dryers and/or separators configured to remove at least a portion of the water from clean syrup stream 128 to form solid product 156 and an exhaust 162. Process 126 may comprise at least one of a cyclone filter system, a baghouse filter system, an electrostatic precipitator, a scrubber, a gravity settling chamber, or a sieve separator, a spray dryer, a rotary dryer, a flash dryer, a tunnel dryer, a conveyor dryer, a counterflow dryer, an air flow dryer, a vacuum dryer, or a heat dryer to remove at least a portion of the water from clean syrup stream 128. Embodiments are contemplated in which at least a portion of the water in clean syrup stream 128 is removed using any now know or later developed techniques, such as the techniques described herein.

Drying clean syrup stream 128 having a lower number of contaminants (e.g., glycerol and/or salt) allows for the production of higher quality products compared to products previously manufactured using whole stillage from ethanol distillation processes. For example, solid product 156 produced via process 126 has a higher protein content that may be sold for a higher price compared to products made using previous techniques, such as wet distillers grains and dried distillers grains. Further, drying a clean syrup stream 128 that has a lower glycerol content compared to syrup from ethanol distillation processes prevents or reduces the formation of tars. For example, drying clean syrup stream 128 may produce less tar than drying a syrup stream directly from an evaporator of an ethanol distillation process.

In some embodiments, clean syrup stream 128 may be similar to clean syrup stream 120 depicted in FIG. 1. Further, clean syrup stream 128 may be the same stream as clean syrup stream 120 as depicted in FIG. 1. Accordingly, process 100 and process 126 may be combined to clean and dry a syrup feedstock. For example, a cleaning and drying process may comprise process 100 and process 126 such that clean syrup stream 120 is fed to process 126 as clean syrup stream 128.

Process 126 may comprise a dryer 130 configured to dry clean syrup stream 128. In some embodiments, clean syrup stream 128 may be fed to dryer 130 with a heated air stream 132 to form a mixture 134 comprising the clean syrup stream 128 and the heated air stream 132. In such embodiments, dryer 130 may be configured to transfer the moisture from clean syrup stream 128 to heated air stream 132, such that the solids (e.g., proteins, fibers, and yeast) in mixture 134 are dryer than the solids in clean syrup stream 128. Dryer 130 may be any combination of dryers now know or later developed, including, but not limited to, a spray dryer, a rotary dryer, a flash dryer, a tunnel dryer, a conveyor dryer, a counterflow dryer, an air flow dryer, a vacuum dryer, and a heat dryer. In some embodiments, dryer 130 may be a spray dryer configured to atomize clean syrup stream 128 with heated air stream 132 to facilitate the drying of the solids from clean syrup stream 128.

Process 126 may further comprise a heat exchanger 136 configured to produce heated air stream 132 upstream from dryer 130. In some embodiments, heat exchanger 136 may heat an air stream 138 to a temperature of at least 200°F, at least 300°F, at least 400°F, at least 500°F, at least 600°F, at least 650°F, or at least 700°F to form heated air stream 132. In some embodiments, heat exchanger 136 may heat air stream 138 using the combustion of natural gas 140 with air stream 142 to form heated air stream 132 and a resulting exhaust stream 144 comprising. Heat exchanger 136 may be any combination of heating systems now known or later developed, including, but not limited to, a heat exchanger, a shell and tube heat exchanger, a shell and coil heat exchanger, a feed-effluent heat exchanger, a plate heat exchanger, a plate and frame heat exchanger, a spiral heat exchanger, a furnace, a boiler, a condenser, a burner, and a fired heater. For example, heat exchanger 136 may be a fired heater in which the combustion of natural gas 140 heats one or more tubes or coils having air stream 138 within to form heated air stream 132. Embodiments are contemplated in which heat exchanger 136 may utilize heat from any type of material stream to form heated air stream 132. For example, heat exchanger 136 may utilize heat from any combination of hot oil, steam, air, or other materials to form heated air stream 132.

Process 126 may further comprise one or more separators (e.g., first separator 146 and/or second separator 152 described below) configured to separate mixture 134 into a solid product 156 and an exhaust 162. In some embodiments, process 126 may separate mixture 134 into a solid product 156 and an exhaust 162 using any combination of separators now known or later developed, including, but not limited to, a cyclone filter system, a baghouse filter system, an electrostatic precipitator, a scrubber, a gravity settling chamber, and a sieve separator. For example, process 126 may comprise at least one of a cyclone filter system or a baghouse filter system. As depicted in FIG. 2, process 126 may comprise a first separator 146 configured to separate at least a portion of the solids from mixture 134 to form a solid product 148 and an exhaust 150. In some embodiments, first separator 146 separates at least 80%, at least 85%, at least 90%, at least 95%, or at least 99% of the solids from mixture 134 to form solid product 148. In some embodiments, first separator 146 is a cyclone filter system configured to separate at least a portion of the solids from mixture 134 to form solid product 148.

Process 126 may further comprise a second separator 152 to separate at least a portion of the remaining solids in exhaust 150 exhausted from first separator 146 to form a solid product 154 and an exhaust 158. In some embodiments, second separator 152 separates at least at least 80%, at least 85%, at least 90%, at least 95%, or at least 99% of the solids from exhaust 150 to form solid product 154. In some embodiments, second separate is a baghouse filter system configured to separate solids from exhaust 150. Embodiments are contemplated in which second separator 152 may be omitted such that process 126 comprises a singular separator. Alternatively, process 126 may comprise additional separators to further increase the removal of solids from mixture 134. In some embodiments, at least a portion of heated air stream 132 may be added to exhaust 150 to facilitate the separation of exhaust 150 into solid product 154 and exhaust 158. In some embodiments, solid product 148 and solid product 154 may be combined to form a solid product 156.

As described earlier, solid product 156 is a higher value product compared to previously manufactured products using stillage from ethanol distillation processes. Accordingly, solid product 156 may have a higher protein content and/or a higher total digestible nutrients content compared to previous products manufactured from whole stillage, such as wet distillers grains and dried distillers grains. Solid product 156 may comprise at least 35%, at least 40%, at least 45%, at least 50%, or at least 55% protein, at least 1%, at least 2.5%, at least 5%, at least 7.5%, at least 10%, at least 12.5%, or at least 15% fiber, and/or less than 15%, less than 10%, less than 7.5%, less than 5%, less than 2.5%, less than 1%, less than 0.5%, or less than 0.1% of water. In some embodiments, solid product 156 may have a total digestible nutrients content of at least 70%, at least 75%, at least 80%, at least 85%, at least 90%, or at least 95%.

Exhaust 158 may be further pressurized utilizing a blower 160 to form a pressurized exhaust 162. In some embodiments, pressurized exhaust 162 may have excess heat from heated air stream 132 and be further utilized to heat one or more streams. For example, as described below in FIG. 3, pressurized exhaust 162 may be utilized to condense a dilute glycerol stream. In some embodiments, pressurized exhaust 162 may have a temperature of at least 190°F, at least 200°F, at least 210°F, at least 220°F, at least 230°F, at least 240°F, or at least 250°F. Embodiments are contemplated in which exhaust 158 may be pressurized using any combination of pressurization devices now known or later developed, including, but not limited to, a blower, a compressor, a fan, or a pump.

FIG. 3 depicts a schematic view of an exemplary process 164 for condensing a dilute glycerol stream 166 via heat from a steam stream 184. Process 164 may comprise an evaporator 168 configured to separate a dilute glycerol stream 166 into a condensed glycerol stream 170 and a vapor stream 172. In some embodiments, evaporator 168 utilizes heat from steam stream 184 to evaporate at least a portion of the water from dilute glycerol stream 166 to form condensed glycerol stream 170 and vapor stream 172. Further, process 164 may comprise one or more heat exchangers (e.g., heat exchanger 180 described further below) configured to transfer heat from steam stream 184 to evaporator 168. In some embodiments, condensed glycerol stream 170 comprises at least 5%, at least 7.5%, at least 10%, at least 12.5%, at least 15%, at least 17.5%, or at least 20% glycerol. In some embodiments, vapor stream 172 may be at least 90%, at least 92.5%, at least 95%, at least 97.5%, at least 99%, or at least 99.5% water. Embodiments are contemplated in which evaporator 168 may be any type of separator now know or later developed, including but not limited to an evaporator, a flash tank, a distillation column, a gravity separator, a hydrocyclone, a centrifugal separator, a coalescer, or an electrostatic assisted separator. For example, evaporator 168 may be a flash tank configured to evaporate at least a portion of the water from dilute glycerol stream 166 to form condensed glycerol stream 170 and vapor stream 172. In some embodiments, vapor stream 172 may be recycled as a steam stream to provide heat to one or more streams in an external process. For example, vapor stream 172 may provide heat to one or more evaporators of an ethanol distillation process, such as the ethanol distillation processes described above.

In some embodiments, steam stream 184 may be similar to exhaust 162 depicted in FIG. 2, and dilute glycerol stream 166 may be similar to dilute glycerol stream 116 depicted in FIG. 1. Further, steam stream 184 may be the same stream as exhaust 162 depicted in FIG. 2, and dilute glycerol stream 166 may be the same stream as dilute glycerol stream 116 depicted in FIG. 1. Accordingly, process 100, process 126, and process 164 may be comprised by a process for cleaning and drying a syrup feedstock and recovering heat to condense a dilute glycerol stream.

In some embodiments, an overall process may contain one or more of each of process 100, process 126, and/or process 164. For example, the overall process may comprise a process 100, a plurality of processes 126, and a plurality of processes 164. Accordingly, streams may split to accommodate the plurality of repeat processes such that the repeat processes are run in parallel to each other. For example, clean syrup stream 120 may split into two clean syrup streams to feed clean syrup stream 128 of each process 126. Similarly, a plurality of streams may be combined to accommodate a singular process. For example, a plurality of processes 164 may each have a pressurized water stream 202 such that each pressurized water stream 202 combines to constitute at least a portion of water stream 112 from process 100.

As described earlier, process 164 may comprise a heat exchanger 180 configured to transfer heat from steam stream 184 to dilute glycerol stream 166 and/or evaporator 168 to form condensed glycerol stream 170. Accordingly, condensed glycerol stream 170 may split to form a glycerol stream 176, which is sent to heat exchanger 180, and a condensed glycerol product stream 178. In some embodiments, feeding glycerol stream 176 to heat exchanger 180 forms a heated glycerol stream 182 that is fed back to evaporator 168 to provide heat to evaporator 168 and facilitate the separation of condensed glycerol stream 170 and vapor stream 172. Accordingly, heated glycerol stream 182 may provide at least a portion of the heat required to separate dilute glycerol stream 166 into a condensed glycerol stream 170 and a vapor stream 172. Embodiments are contemplated in which evaporator 168 may receive heat from one or more sources.

Process 164 may further comprise a pump 174 configured to pressurize condensed glycerol stream 170 prior to splitting condensed glycerol stream 170 into glycerol stream 176 and condensed glycerol product stream 178. Pump 174 may pressurize condensed glycerol stream 170 to a pressure of at least 15 psia, at least 25 psia, at least 50 psia, at least 75 psia, at least 100 psia, at least 125 psia, or at least 150 psia. For example, pump 174 may pressurize condensed glycerol stream 170 to a pressure of 50 psia. Embodiments are contemplated in which pump 174 is omitted from process 164. For example, condensed glycerol stream 170 may not require further pressurization and therefore may not be fed to pump 174.

In some embodiments, process 164 may further comprise a heat scrubber 186 configured to condense water in steam stream 184 to produce a hot water stream 188 and an air stream 190. Heat scrubber 186 may condense at least a portion of steam stream 184 by spraying a water stream at a lower temperature than the steam stream 184 within heat scrubber 186 such that the temperature of steam stream 184 is lowered and the temperature of the sprayed water is increased. Such an exchange of heat causes at least a portion of the water in steam stream 184 to condense and mix with the sprayed water to form hot water stream 188.

In some embodiments, at least a portion of hot water stream 188 may be sent to heat exchanger 180. Hot water stream 188 may be split into a first hot water stream 194 configured to be fed to heat exchanger 180 and a second hot water stream 196. Further, first hot water stream 194 and glycerol stream 176 may be sent to heat exchanger 180 such that heat is transferred from first hot water stream 194 to glycerol stream 176. For example, feeding first hot water stream 194 and glycerol stream 176 to heat exchanger 180 may increase the temperature of glycerol stream 176 by at least 5°F, at least 7.5°F, at least 10°F, at least 12.5°F, or at least 15°F. Similarly, hot water stream 188 may be cooled via heat exchanger 180 to form a cooled water stream 198.

Cooled water stream 198 may be fed back to heat scrubber 186 to facilitate the condensation of water within steam stream 184 to form hot water stream 188. Further, feeding cooled water stream 198 to heat scrubber 186 may remove heat from air stream 190 prior to exiting heat scrubber 186. For example, cooled water stream 198 may be sprayed within heat scrubber 186 to condense water from steam stream 184 to form hot water stream 188 and air stream 190. Embodiments are contemplated in which cooled water stream 198 may further be cooled via one or more heat exchangers prior to entering heat scrubber 186. For example, an auxiliary cooler may be utilized to regulate the temperature of cooled water stream 198 for startup, shutdown, and trim control of process 164.

In some embodiments, second hot water stream 196 may be recycled and used in one or more processes, such as the processes described herein. For example, second hot water stream 196 may be recycled and constitute at least a portion of water stream 112 as described above in FIG. 1. In some embodiments, process 164 may comprise one or more filters configured to remove solids from hot water stream 188, first hot water stream 194, and/or second hot water stream 196. For example, process 164 may have a filter to reduce the number of solids in hot water stream 188 and reduce fouling of downstream units. Embodiments are contemplated in which process 164 does not comprise a filter. For example, hot water stream 188 may have little to no solids and therefore not require filtration.

In some embodiments, process 164 further comprises one or more pumps configured to pressurize the above-described hot water streams. Process 164 may comprise a pump 192 to pressurize hot water stream 188 prior to splitting hot water stream 188 into first hot water stream 194 and second hot water stream 196. Process 164 may further comprise a pump 200 to further pressurize second hot water stream 196 and form pressurized water stream 202. In some embodiments, pressurized water stream 202 may be recycled to constitute at least a portion of water stream 112 as described above in FIG. 1. Process 164 may further comprise a blower 204 to pressurize air stream 190 to form a pressurized air stream 206. Pressurized air stream 206 may be recycled to constitute at least a portion of air stream 138 as described above in FIG. 2. Embodiments are contemplated in which air stream 190 may be pressurized using any combination of pressurization devices now known or later developed, including, but not limited to, the pressurization devices described herein.

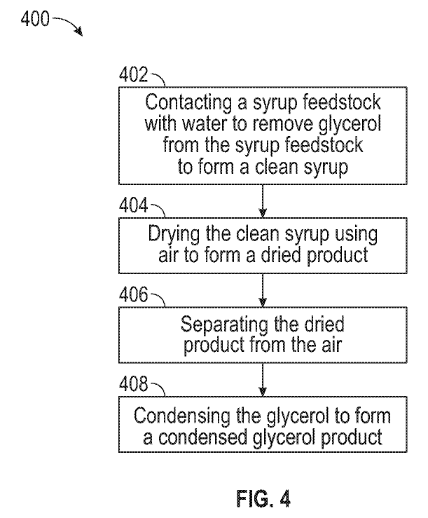

FIG. 4. depicts a method 400 for cleaning and drying a syrup feedstock (e.g., syrup feedstock stream 102) to form one or more products (e.g., solid product 156). In some embodiments, method 400 may be performed using any combination of process 100, process 126, and process 164 as described above. At step 402, a syrup feedstock may be contacted with water to remove contaminants (e.g., glycerol) from the syrup feedstock to form a clean syrup. In some embodiments, step 402 may be performed using process 100 described in FIG. 1.

In some embodiments, step 402 includes feeding syrup feedstock and water through a washing chamber to remove at least a portion of contaminants such as glycerol and/or salt from the syrup feedstock and form a clean syrup and a dilute glycerol. In some embodiments, the washing chamber may be similar to washing chamber 110 depicted in FIG. 1. For example, the syrup feedstock may flow through the washing chamber in a first direction and the water may flow through the washing chamber in a second direction to remove at least a portion of the glycerol from the syrup feedstock. In some embodiments, step 402 further comprises flowing the syrup feedstock through one or more filters and/or separators to remove solids having a diameter of 400 μm or greater, 350 μm or greater, 300 μm or greater, 250 μm or greater, 200 μm or greater, 150 μm or greater, or 100 μm or greater from syrup feedstock stream 102. For example, may flow through one or more filters and/or separators prior to being fed to the washing chamber.

At step 404, the clean syrup is dried using air to form a dried product. One or more dryers may be utilized to dry the clean syrup. In some embodiments, step 404 may be performed using process 126 described in FIG. 2. Drying the clean syrup includes removing at least a portion of the water from the clean syrup to form the dried product. In some embodiments, step 404 includes mixing the clean syrup with air such that at least a portion of the water is transferred from the clean syrup to the air. Drying the clean syrup may be performed by one or more dryers, such as dryer 130 described above in FIG. 2. For example, the clean syrup may be fed to a spray dryer configured to atomize the clean syrup into the air to form a mixture comprising solids, water, and air. In some embodiments, the air may be heated to facilitate the removal of water from the clean feedstock to the air. For example, the air may be heated using one or more heat exchangers, such as heat exchanger 136 described above in FIG. 2. Embodiments are contemplated in which other methods of drying the clean syrup may be utilized. For example, clean syrup may be dried using a drying oven configured to remove moisture from the clean syrup via heat. Further, the drying oven may have a conveyor belt for moving the clean syrup through the drying oven such that clean syrup enters the drying oven and a dried product comprising dried solids and an exhaust comprising water vapor exit the drying oven. Step 404 may be performed using any combination of a spray dryer, a rotary dryer, a flash dryer, a tunnel dryer, a conveyor dryer, a counterflow dryer, an air flow dryer, a vacuum dryer, or a heat dryer.

At step 406, the dried product is separated from the air. One or more separators may be utilized to separate the dried product from the air. In some embodiments, step 406 may be performed using process 126 described in FIG. 2. For example, step 406 may be performed using any combination of a cyclone filter system, a baghouse filter system, an electrostatic precipitator, a scrubber, a gravity settling chamber, or a sieve separator. Step 406 may include feeding the mixture of solids and air to one or more separators to form a dried product and an exhaust. The dried product comprises dried solids from the clean syrup as described above. Accordingly, the dried product may comprise at least 35%, at least 40%, at least 45%, at least 50%, or at least 55% protein, at least 1%, at least 2.5%, at least 5%, at least 7.5%, at least 10%, at least 12.5%, or at least 15% fiber, at least 5%, at least 10%, at least 15%, at least 20%, or at least 25% yeast, and/or less than 15%, less than 10%, less than 7.5%, less than 5%, less than 2.5%, less than 1%, less than 0.5%, or less than 0.1% of water. For example, the dried product may be a dried protein product comprising at least 35% protein and/or the dried product may be a dried yeast product comprising at least 5% yeast. Further, the exhaust comprises the air and water separated from the dried product. Embodiments are contemplated in which step 404 and step 406 may be performed simultaneously. Accordingly, clean syrup may be dried while separating air and water vapor from the dried product. For example, a drying oven may dry the clean syrup while separating the dried product from the air having the moisture from the clean syrup.

At step 408, the dilute glycerol stream separated at step 402 is condensed to form a condensed glycerol product. Condensing the dilute glycerol stream forms a glycerol product stream. In some embodiments, step 408 may be performed using process 164 described in FIG. 3. Step 408 may include feeding the dilute glycerol from step 402 to one or more separators to remove at least a portion of the water from the dilute glycerol to thereby condense the dilute glycerol and form a condensed glycerol product. One or more separators may utilize heat from the exhaust from step 406 to facilitate the condensation of dilute glycerol to form the condensed glycerol product. For example, one or more heat exchangers may be utilized to transfer heat from the exhaust to the dilute glycerol and/or one or more separators.

In some embodiments, step 408 includes feeding the exhaust from step 406 to a heat scrubber to condense the water within the exhaust. Step 408 may further include spraying water in the heat scrubber to remove heat from the air to form a hot water stream. In some embodiments, the condensed water from the exhaust and the sprayed water combine to form the hot water stream. Step 408 may further include feeding the hot water stream and at least a portion of the dilute glycerol to a heat exchanger to heat the portion of the dilute glycerol. The heated portion of the dilute glycerol may be fed back to one or more separators to facilitate the condensation of the dilute glycerol to form the condensed glycerol product. Embodiments are contemplated in which step 408 may be optional, such that step 408 may be omitted from method 400.

Features described above as well as those claimed below may be combined in various ways without departing from the scope hereof. The following examples illustrate some possible, non-limiting combinations:

Clause 1. A process for cleaning and drying a syrup feedstock comprising protein, fiber, and glycerol, the process comprising: flowing the syrup feedstock through a membrane system in a first direction; flowing water through the membrane system in a second direction opposite the first direction such that the syrup feedstock contacts the water to remove at least a portion of the glycerol from the syrup feedstock to form a clean syrup and dilute glycerol; mixing the clean syrup with air to dry the clean syrup; separating a dried product from the air using one or more separators, wherein the dried product comprises at least 40% protein and at least 5% fibers; and condensing the dilute glycerol via an evaporator using heat from the air to form a glycerol product, wherein the glycerol product comprises at least 10% glycerol.

Clause 2. The process of clause1, further comprising: heating the air to a temperature of at least 300°F via a fired heater.

Clause 3. The process of any of clauses 1 or 2, wherein separating the dried product from the air includes feeding a mixture comprising the clean syrup and the air to a baghouse filter system.

Clause 4. The process of any of clauses 1 through 3, wherein separating the dried product from the air further includes feeding the mixture to a cyclone filter system prior to feeding the mixture to the baghouse filter system.

Clause 5. The process of any of clauses 1 through 4, further comprising prior to feeding the syrup feedstock to the membrane system, feeding the syrup feedstock to a strainer to remove solids having a diameter of 300 μm or greater.

Clause 6. The process of any of clauses 1 through 5, wherein mixing the clean syrup with the air includes feeding the clean syrup and the air to a spray dryer.

Clause 7. The process of any of clauses 1 through 6, wherein the one or more separators comprises at least one of a cyclone filter system, a baghouse filter system, an electrostatic precipitator, a scrubber, a gravity settling chamber, or a sieve separator.

Clause 8. A process for cleaning and drying a syrup feedstock comprising protein, fiber, and glycerol, the process comprising: feeding the syrup feedstock and water to a washing chamber such that the syrup feedstock contacts the water to remove at least a portion of the glycerol from the syrup feedstock to form a clean syrup and dilute glycerol; and removing water from the clean syrup via one or more separators or dryers to form a dried product, wherein the dried product comprises at least 40% protein.

Clause 9. The process of clause 8, further comprising condensing the dilute glycerol to form a glycerol product comprising at least 15% glycerol.

Clause 10. The process of any of clauses 8 or 9, further comprising: flowing the syrup feedstock through the washing chamber in a first direction; and flowing the water through the washing chamber in a second direction opposite the first direction.

Clause 11. The process of any of clauses 8 through 10, wherein the washing chamber is a membrane system configured to remove at least a portion of water-soluble contaminants from the syrup feedstock to form the clean syrup.

Clause 12. The process of any of clauses 8 through 11, wherein the one or more separators or dryers comprises at least one of a cyclone filter system, a baghouse filter system, an electrostatic precipitator, a scrubber, a gravity settling chamber, or a sieve separator, a spray dryer, a rotary dryer, a flash dryer, a tunnel dryer, a conveyor dryer, a counterflow dryer, an air flow dryer, a vacuum dryer, or a heat dryer.

Clause 13. The process of any of clauses 8 through 12, wherein the one or more separators includes the spray dryer, the cyclone filter system, and the baghouse filter system.

Clause 14. The process of any of clauses 8 through 13, further comprising prior to feeding the syrup feedstock to the washing chamber, feeding the syrup feedstock to one or more filters to remove at least a portion of solids having a diameter of 200 μm or greater.

Clause 15. A process for cleaning and drying a syrup feedstock comprising protein, fiber, and glycerol, the process comprising: flowing the syrup feedstock through a washing chamber in a first direction; flowing water through the washing chamber in a second direction such that the syrup feedstock contacts the water to remove at least a portion of the glycerol from the syrup feedstock to form a clean syrup and dilute glycerol; feeding the clean syrup to a spray dryer such that the clean syrup mixes with air having a temperature of at least 300°F to dry the clean syrup; separating a dried product from the air using at least one of a cyclone filter system or a baghouse filter system, wherein the dried product comprises at least 35% protein and at least 5% fibers; and condensing the dilute glycerol via heat from the air to form a glycerol product, wherein the glycerol product comprises at least 10% glycerol.

Clause 16. The process of clause 15, wherein condensing the dilute glycerol comprises: feeding the air from the at least one of the cyclone filter system or the baghouse filter system to a heat scrubber; spraying water in the heat scrubber to remove heat from the air to form a hot water stream; feeding the hot water stream and at least a portion of the dilute glycerol to a heat exchanger to heat the portion of the dilute glycerol; and feeding the portion of the dilute glycerol to an evaporator to condense the dilute glycerol to form the glycerol product.

Clause 17. The process of any of clauses 15 or 16, wherein the water sprayed in the heat scrubber comprises the hot water stream after being fed to the heat exchanger to heat the portion of the dilute glycerol.

Clause 18. The process of any of clauses 15 through 17, wherein the dilute glycerol is fed to the evaporator to evaporate at least a portion of water in the dilute glycerol to form the glycerol product.

Clause 19. The process of any of clauses 15 through 18, wherein the washing chamber removes at least 75% of the glycerol from the syrup feedstock to form the clean syrup.

Clause 20. The process of any of clauses 15 through 19, wherein the dried product comprises less than 15% water.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. A process for cleaning and drying a syrup feedstock comprising protein, fiber, and glycerol, the process comprising:
flowing the syrup feedstock through a membrane system in a first direction;
flowing water through the membrane system in a second direction opposite the first direction such that the syrup feedstock contacts the water to remove at least a portion of the glycerol from the syrup feedstock to form a clean syrup and dilute glycerol;
mixing the clean syrup with air to dry the clean syrup;
separating a dried product from the air using one or more separators,
wherein the dried product comprises at least 40% protein and at least 10% fibers; and
condensing the dilute glycerol via an evaporator using heat from the air to form a glycerol product,
wherein the glycerol product comprises at least 10% glycerol.

2. The process of claim 1, further comprising:
heating the air to a temperature of at least 300°F via a heater.

3. The process of claim 1, wherein separating the dried product from the air includes feeding a mixture comprising the clean syrup and the air to a baghouse filter system.

4. The process of claim 3, wherein separating the dried product from the air further includes feeding the mixture to a cyclone filter system prior to feeding the mixture to the baghouse filter system.

5. The process of claim 1, further comprising prior to feeding the syrup feedstock to the membrane system, feeding the syrup feedstock to a strainer to remove solids having a diameter of 300 μm or greater.

6. The process of claim 1, wherein mixing the clean syrup with the air includes feeding the clean syrup and the air to a spray dryer.

7. The process of claim 1, wherein the one or more separators comprises at least one of a cyclone filter system, a baghouse filter system, an electrostatic precipitator, a scrubber, a gravity settling chamber, or a sieve separator.

8. A process for cleaning and drying a syrup feedstock comprising protein, fiber, and glycerol, the process comprising:
feeding the syrup feedstock and water to a washing chamber such that the syrup feedstock contacts the water to remove at least a portion of the glycerol from the syrup feedstock to form a clean syrup and dilute glycerol; and
removing water from the clean syrup via one or more separators or dryers to form a dried product,
wherein the dried product comprises at least 50% protein.

9. The process of claim 8, further comprising condensing the dilute glycerol to form a glycerol product comprising at least 15% glycerol.

10. The process of claim 8, further comprising:
flowing the syrup feedstock through the washing chamber in a first direction; and
flowing the water through the washing chamber in a second direction opposite the first direction.

11. The process of claim 10, wherein the washing chamber is a membrane system configured to remove at least a portion of water-soluble contaminants from the syrup feedstock to form the clean syrup.

12. The process of claim 8, wherein the one or more separators or dryers comprises at least one of a cyclone filter system, a baghouse filter system, an electrostatic precipitator, a scrubber, a gravity settling chamber, or a sieve separator, a spray dryer, a rotary dryer, a flash dryer, a tunnel dryer, a conveyor dryer, a counterflow dryer, an air flow dryer, a vacuum dryer, or a heat dryer.

13. The process of claim 12, wherein the one or more separators includes the spray dryer, the cyclone filter system, and the baghouse filter system.

14. The process of claim 8, further comprising prior to feeding the syrup feedstock to the washing chamber, feeding the syrup feedstock to one or more filters to remove at least a portion of solids having a diameter of 200 μm or greater.

15. A process for cleaning and drying a syrup feedstock comprising protein, fiber, and glycerol, the process comprising:
flowing the syrup feedstock through a washing chamber in a first direction;
flowing water through the washing chamber in a second direction such that the syrup feedstock contacts the water to remove at least a portion of the glycerol from the syrup feedstock to form a clean syrup and dilute glycerol;
feeding the clean syrup to a spray dryer such that the clean syrup mixes with air having a temperature of at least 300°F to dry the clean syrup;
separating a dried product from the air using at least one of a cyclone filter system or a baghouse filter system,
wherein the dried product comprises at least 35% protein and at least 5% fibers; and
condensing the dilute glycerol via heat from the air to form a glycerol product,
wherein the glycerol product comprises at least 10% glycerol.

16. The process of claim 15, wherein condensing the dilute glycerol comprises:
feeding the air from at least one of the cyclone filter system or the baghouse filter system to a heat scrubber;
spraying water in the heat scrubber to remove heat from the air to form a hot water stream;
feeding the hot water stream and at least a portion of the dilute glycerol to a heat exchanger to heat the portion of the dilute glycerol; and
feeding the portion of the dilute glycerol to an evaporator to condense the dilute glycerol to form the glycerol product.

17. The process of claim 16, wherein the water sprayed in the heat scrubber comprises the hot water stream after being fed to the heat exchanger to heat the portion of the dilute glycerol.

18. The process of claim 16, wherein the dilute glycerol is fed to the evaporator to evaporate at least a portion of water in the dilute glycerol to form the glycerol product.

19. The process of claim 15, wherein the washing chamber removes at least 75% of the glycerol from the syrup feedstock to form the clean syrup.

20. The process of claim 15, wherein the dried product comprises less than 15% water.
